(19) United States
(12) Patent Application Publication
(10) Pub. No.: US 2026/0152133 A1
(43) Pub. Date: Jun. 4, 2026

(54) Composite for External Trim of a Motor Vehicle

(71) Applicant: Bayerische Motoren Werke Aktiengesellschaft, Muenchen (DE)

(72) Inventors: Florian MEINDL, Pemmering (DE); Hubert OBERMEIER, Guending (DE)

(21) Appl. No.: 18/706,809

(22) PCT Filed: Oct. 18, 2022
(86) PCT No.: PCT/EP2022/078955

§ 371 Date: May 2, 2024

(30) Foreign Application Priority Data
Nov. 18, 2021 (DE) 10 2021 130 195.5

(51) Int. Cl. B60R 13/04; B29C 65/50; B29C 65/56; B29C 65/72; B29L 31/30

(52) U.S. Cl. CPC B60R 13/04; B29C 65/50; B29C 65/56; B29C 65/72; B29L 2031/3041

(57) ABSTRACT

A composite for an external trim of a motor vehicle includes an external trim part which is made of plastic and is interconnected to an under part made of plastic by way of a joint connection arranged between an inner face of the external trim part and an outer face of the under part. At least one holder is adhered to the inner face of the external trim part, which holder interacts with a holder receptacle of the under part in order to secure the external trim part on the under part if the adhesive connection fails.

### BACKGROUND AND SUMMARY

The invention relates to a composite for an external trim of a motor vehicle.

Such a composite is, for example, already known from EP 3 339 145 A1 and comprises an external trim part made of plastic which is connected to an underpart made of plastic by means of a joining connection in the form of an adhesive connection which is arranged between an inner side of the external trim part and an outer side of the underpart.

In such multi-shell external trims or external skin components made of plastic, a failure of the joining connection between the external trim part and the underpart may occur. In such a failure case, it is possible in certain circumstances for the external trim part to be completely detached and, for example, to become a danger to road traffic, in particular for the traffic following the motor vehicle. For this reason, it is already known to provide, on the one hand, catch straps and, on the other hand, securing elements on the inner side of the external trim part which can be produced, for example, by so-called hot stamping, that is to say the provision of holders by corresponding heating and forming of the plastics material.

In the case of external trim parts without prominent surface configuration of the external skin, that is to say, for example, for external trim parts which are substantially planar or extend substantially flat, the aforementioned securing possibilities are noticeable on the visible surface of the external trim part as a result of the geometries, such as, for example, tabs, ribs or the like, to be provided on the external trim part for the connection between the external trim part and the underpart.

It is therefore the object of the present invention to provide a composite of the type stated at the outset by means of which improved and visually imperceptible securing of the external trim part on the underpart can be realized.

This object is achieved by a composite having the features of the independent claims. Advantageous embodiments with favorable developments of the invention form the subject matter of the dependent claims.

The composite according to the invention for an external trim of a motor vehicle comprises an external trim part and an underpart which are connected to one another by means of a joining connection, for example an adhesive connection or a welded connection, between the inner side of the external trim part and the outer side of the underpart. In order to reliably avoid complete removal of the external trim part from the underpart in a failure case, that is to say in the event of the joining connection being released, according to the invention at least one holder which is adhered to the inner side of the external trim part is provided, which holder interacts with a holder receptacle of the underpart in order to secure the external trim part on the underpart in the event of a failure of the joining connection.

Therefore, according to the invention, at least one holder is fastened to the inner side of the external trim part for example and, in particular, by means of an adhesive connection, which holder makes it possible to avoid the external trim part being released from the underpart in the event of failure of the actual adhesive connection, which is also referred to as the primary adhesive connection. The key advantage of adhering the holder to the inner side of the external trim part is its unnoticeable fastening to the inner side of the external trim part, with the result that the corresponding holder cannot be noticed from outside, by contrast with previous methods. By suitably choosing the corresponding adhesive connection between the holder and the inner side of the external trim part, in particular by choosing the suitable adhesive tape, there is thus ensured, on the one hand, reliable securing of the external trim part on the underpart and, on the other hand, unnoticeable fastening of the holder to the external trim part, without the holder being visible from outside the external trim part.

In an advantageous embodiment of the invention, a clearance is provided between the holder and the holder receptacle. This means that the holder is not caused to act when there is a functioning primary adhesive connection between the inner side of the external trim part and the outer side of the underpart, but rather acts only if the primary adhesive connection or similar joining connection fails and the trim part threatens to fall off the underpart.

A further advantageous embodiment provides that the holder is adhesively bonded to the inner side of the external trim part by means of an adhesive tape. Such high-performance adhesive tapes ensure, on the one hand, secure fixing of the holder to the inner side of the external trim part and, on the other hand, an unnoticeable arrangement, with the result that the holder or its fastening point is not discernible from outside on the surface of the external trim part.

In this connection, it has been shown to be further advantageous if the adhesive tape used is an acrylic foam adhesive tape. Such acrylic foam adhesive tapes are extremely favorable and, moreover, highly effective and durable in terms of their adhesive performance.

Furthermore, it has been shown to be advantageous if the holder has a holder head which is engaged from behind by respective form-fitting elements of the holder receptacle. These form-fitting elements preferably come into use only when falling or release of the external trim part from the underpart threatens or is imminent. Conversely, this means that, although the form-fitting elements of the holder receptacle engage behind the holder head when the joining connection is functioning, they are not directly in contact with the holder head, but rather have a corresponding clearance. Since there is thus preferably no contact between the holder and the holder receptacle when the joining connection, for example the primary adhesive connection, is functioning, the holder is also initially not loaded or used for holding functions in normal operation, but is used only for securing functions if the joining connection, for example the primary adhesive connection, threatens to fail.

In a further embodiment of the invention, there is provision that the holder is formed from a plastic. Such a holder can be adhesively bonded particularly favorably on the inner side of the external trim part and is also correspondingly favorable in terms of weight.

Furthermore, it has been shown to be advantageous if the holder receptacle is formed in one piece with the underpart. This allows a particularly simple and cost-effective holder receptacle to be provided.

In a further embodiment of the invention, a particularly simple joining connection between the external trim part and the underpart can be realized if it is an adhesive connection.

Finally, it has been shown to be advantageous if the adhesive connection between the external trim part and the underpart and the adhesive bond between the holder and the external trim part are produced by different adhesives or bonding agents. This ensures in particular that the two adhesives do not fail at the same time.

Further features of the invention will emerge from the claims, the figures and the description of the figures. The features and combinations of features mentioned above in the description and also the features and combinations of features mentioned below in the description of the figures and/or shown in the figures alone may be used not only in the respectively specified combination but also in other combinations or in isolation.

The invention will now be explained in more detail on the basis of a preferred exemplary embodiment and with reference to the drawings.

### BRIEF DESCRIPTION OF THE DRAWINGS

FIG. 1 is a perspective sectional detail view of a composite and an external trim of a motor vehicle having an external trim part made of plastic and an underpart likewise made of plastic which are connected to one another by an adhesive connection, wherein a holder is adhered to the inner side of the external trim part, which holder interacts with a holder receptacle of the underpart in order to secure the external trim part on the underpart in the event of a failure of the adhesive connection; and

FIG. 2 is a further perspective detail view of the composite according to FIG. 1, in which there can be seen two holders by which the external trim part is secured on the underpart.

### DETAILED DESCRIPTION OF THE DRAWINGS

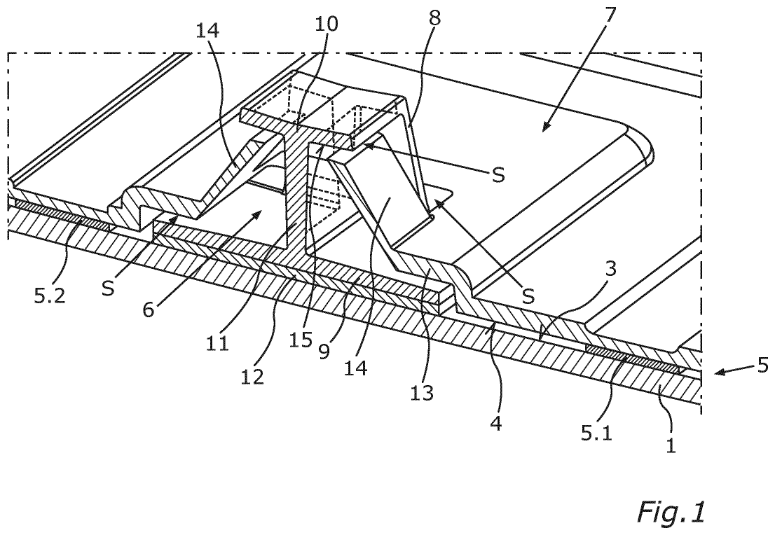

FIG. 1 is a perspective detail view illustrating a composite for an external trim of a motor vehicle. In the present case, this multi-shell external trim is formed by an external trim part 1 made of a plastic which forms the external skin of the motor vehicle at least in certain regions and which, together with an underpart 2, which is likewise formed from a plastic, forms the composite. Here, an adhesive connection 5, which in the present case is formed by a plurality of individual adhesive connections 5.1 and 5.2, is provided between an inner side 3 of the external trim part 1 and an outer side 4 of the underpart 2. Alternatively, it is also possible to use a different kind of joining connection between the inner side 3 of the external trim part 1 and the outer side 4 of the underpart 2, for example a welded connection. In the present case, the external trim part 1 and the underpart 2 can be formed, for example, from a corresponding thermoplastic material, for example from PC or from TP or from a thermoplastic terpolymer, for example an ABS. The adhesive connection 5 arranged between these two plastic components 1, 2 may be, for example, a one-or two-component adhesive.

The adhesive connection 5 here forms that joining connection between the underpart 2 and the external trim part 1 which interconnects the components customarily or in the normal state. Therefore, the adhesive connection 5 is also referred to as the primary adhesive connection.

However, it is possible as a result of external influences for a failure, and possibly also a complete failure, of the joining connection/adhesive connection 5 to occur in such multi-shell external skin components. In such a failure case, the external trim part 1 then threatens to become completely detached from the underpart 2, which in turn can lead to dangerous situations for road traffic, in particular for the traffic following the motor vehicle.

For this reason, there is provided in the present case at least one holder 6 which is adhered to the inner side 3 of the external trim part 1 and which interacts with a corresponding holder receptacle 7 of the underpart 2 in order to secure the external trim part 1 on the underpart in the event of a failure of the adhesive connection 5.

As can be seen from FIG. 1, the holder 6 is substantially double-T-shaped and, toward one side, additionally has a cheek 8 which connects a base 9 to a holder head 10. Also provided is a central web 11 which connects the base 9 to the holder head 10. In the present case, the holder 6 is in particular formed from a plastic, for example likewise from a thermoplastic material. Of course, other configurations are also possible.

Moreover, in the present exemplary embodiment, the holder 6 is fastened to the inner side 3 of the external trim part 1 by means of an adhesive tape 12, in particular in the form of an acrylic foam adhesive tape. Instead of the adhesive tape 12, another type of adhesive connection between the holder 6 and the external trim part 1 is of course also conceivable.

In the present case, the holder receptacle 7 has been formed in one piece with the underpart 2 or has undergone corresponding primary forming or shaping. Here, the holder receptacle has a substantially rectangular depression 13 which is set back from the outer side 4 of the underpart 2 and from which two tab-like form-fitting elements 14 project in the direction of an outer side 15 of the holder head 10.

It can be seen here from FIG. 1 that, although the form-fitting elements 14 engage behind the holder head 10, they are not directly in contact therewith. Rather, a corresponding clearance s is provided between the holder 6 and the holder receptacle 7 in the region between the free ends of the form-fitting elements 14 and the outer side 15 of the holder 10, such that, with an intact assembly of the external trim part 1 and the underpart 2, that is to say when the two components are properly connected to one another by means of the adhesive connection 5, the form-fitting elements 14 are not in contact with the holder head 10.

Such a clearance is also provided between the depression 13 of the underpart 2 and the base 9 of the holder 6. The holder receptacle 7 also has a correspondingly large cutout S such that the underpart 2 in the present case is not in contact with the cheek 8 of the holder 6. With a proper and intact assembly of the external trim part 1 and the underpart 2, the holder 6 is accordingly not in contact with the holder receptacle 7 or with the underpart 2 at any point. Rather, corresponding free spaces or clearances s are provided all over.

Accordingly, the holder 6 is only used if a failure case of the adhesive connection 5 between the external trim part 1 and the underpart 2 occurs. In particular, the external trim part 1 is then held on the underpart 2 via the holder 6 by virtue in particular of the form-fitting elements 14 coming into bearing contact with the holder head 10. In such a failure case, the holder receptacle 7 ensures that the holder 6, and thus the external trim part 1, cannot be released from the underpart 2 or the holder receptacle 7.

Here, different adhesives or adhesive tapes are ideally provided for the adhesive connection 5 between the external trim part 1 and the underpart 2 and for the adhesive bond 12 between the holder 6 and the external trim part 1. It is thus ensured that, in the event of a failure of the adhesive connection 5, there is a high probability that the adhesive bond 12, which is formed here by an adhesive tape, does not also fail or has not already failed.

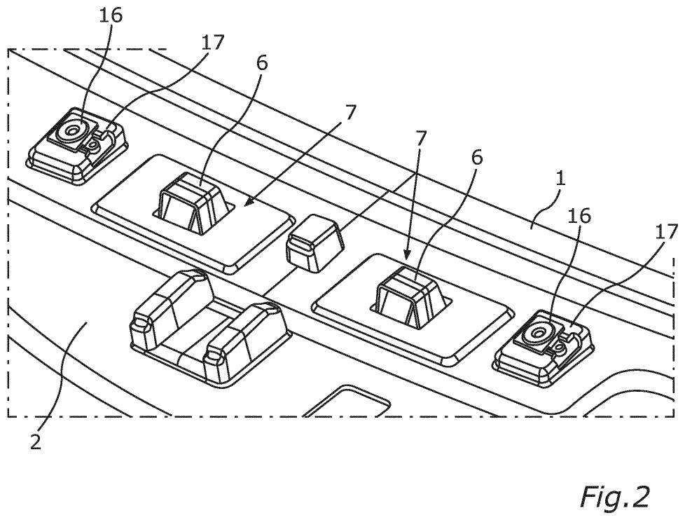

FIG. 2 is a perspective detail view illustrating the composite analogous to FIG. 1, in which there can be seen in particular two holders 6 which engage in corresponding holder receptacles 7. Also visible on the underpart 2 are respective fastening elements 16 by means of which the underpart 2 can be fastened, for example, to the motor vehicle bodyshell. These fastening elements 16 interact with corresponding fastening receptacles 17 belonging to the underpart 2.

### LIST OF REFERENCE SIGNS

1 External trim part
2 Underpart
3 Inner side
4 Outer side
5 Adhesive connection
6 Holder
7 Holder receptacle
8 Cheek
9 Base
10 Holder head
11 Web
12 Adhesive tape
13 Depression
14 Form-fitting elements
15 Outer side
16 Cutout
17 Fastening receptacles

1.-9. (canceled)

10. A composite for an external trim of a motor vehicle, comprising:
an external trim part made of plastic;
an underpart made of plastic to which the internal trim part is connected via a joining connection arranged between an inner side of the external trim part and an outer side of the underpart; and
at least one holder adhered to the inner side of the external trim part, which holder interacts with a holder receptacle of the underpart in order to secure the external trim part on the underpart in an event of a failure of the joining connection.

11. The composite according to claim 10, wherein
a clearance is provided between the holder and the holder receptacle.

12. The composite according to claim 10, wherein
the holder is adhesively bonded to the inner side of the external trim via an adhesive tape.

13. The composite according to claim 12, wherein
the adhesive tape is an acrylic foam adhesive tape.

14. The composite according to claim 10, wherein
the holder has a holder head which is engaged from behind by respective form-fitting elements of the holder receptacle.

15. The composite according to claim 10, wherein
the holder is formed of a plastic.

16. The composite according to claim 10, wherein
the holder receptacle is formed in one piece with the underpart.

17. The composite according to claim 10, wherein
the joining connection between the external trim part and the underpart is an adhesive connection.

18. The composite according to claim 17, wherein
the adhesive connection between the external trim part and the underpart, and the adhesive bond between the holder and the external trim part, are formed by different adhesives.
